(19) United States
(12) Patent Application Publication
(10) Pub. No.: US 2023/0392678 A1
(43) Pub. Date: Dec. 7, 2023

(54) GEARBOX WITH INTERNAL CARRIER

(71) Applicant: Motus Labs, LLC, Dallas, TX (US)

(72) Inventor: Carlos A. Hoefken, Dallas, TX (US)

(21) Appl. No.: 18/205,875

(22) Filed: Jun. 5, 2023

Related U.S. Application Data
(60) Provisional application No. 63/348,943, filed on Jun. 3, 2022.

(51) Int. Cl. F16H 57/02; F16H 53/02; F16H 53/06; F16H 1/28

(52) U.S. Cl. CPC F16H 57/02004; F16H 53/025; F16H 53/06; F16H 1/2836; F16H 1/2863; F16H 57/031

(57) ABSTRACT

The present disclosure relates to a gear box mechanism with a carrier for housing a plurality of gear blocks, a retainer cam, a cam shaft, and a plurality of cam followers. The gear blocks can interact with a ring gear allowing an output to be driven. The carrier can be housed within a first lid, and a second lid. The plurality of gear blocks can be driven by the cam shaft that has a plurality of cam pathways along an outer circumferential surface of the cam shaft. Additionally, the retainer cam has a retention pathway along an inner surface of the retainer cam. One or more of the plurality of cam followers engage with the cam pathways and the retention pathway, allowing the plurality of gear blocks to be actuated based on the position of the plurality of cam followers along the retention pathway and the cam pathways.

### CROSS-REFERENCE TO RELATED APPLICATIONS

This application claims benefit of U.S. Provisional Application No. 63/348,943, filed on Jun. 3, 2022, entitled “Gearbox with Internal Carrier,” the disclosure of which is hereby incorporated by reference in its entirety.

### BACKGROUND

### Technical Field

The present disclosure relates to gearbox. More particularly, and not by way of limitation, the present disclosure is directed to an apparatus, system or method for a gearbox with an internal carrier system.

### Description of Related Art

Conventional machines typically consist of a power source and a power transmission system, which provides controlled application of the power. A variety of proposals have previously been made in the art of power transmission systems. The simplest transmissions, often called gearboxes to reflect their simplicity (although complex systems are also called gearboxes in the vernacular), provide gear reduction (or, more rarely, an increase in speed), sometimes in conjunction with a change in direction of the powered shaft. A transmission system may be defined as an assembly of parts including a speed-changing gear mechanism and an output shaft by which power is transmitted from the power source (e.g., electric motor) to an output shaft. Often transmission refers simply to the gearbox that uses gears and gear trains to provide speed and torque conversions from a power source to another device.

Gearboxes have been used for many years and they have many different applications. In general, conventional gearboxes comprise four main elements: power source; drive train; housing and output means. The power source places force and motion into the drive train. The power source may be a motor connected to the drive train through suitable gearing, such as a spur, bevel, helical or worm gear.

The drive train enables the manipulation of output motion and force with respect to the input motion and force provided by the power source. The drive train typically comprises a plurality of gears of varying parameters such as different sizes, number of teeth, tooth type and usage, for example spur gears, helical gears, worm gears and/or internal or externally toothed gears.

The gearbox housing is the means which retains the internal workings of the gearbox in the correct manner. For example, it allows the power source, drive train and output means to be held in the correct relationship for the desired operation of the gearbox. The output means is associated with the drive train and allows the force and motion from the drive train to be applied for an application. Usually, the output means exits the gearbox housing.

The output means typically can be connected to a body whereby the resultant output motion and force from the drive train is transmitted via the output means (e.g., an output shaft) to the body to impart the output mean's motion and force upon the body. Alternatively, the output means can impart the motion and force output from the drive train to the gearbox housing whereby the output means is held sufficiently as to allow the gearbox housing to rotate.

Rotating power sources typically operate at higher rotational speeds than the devices that will use that power. Consequently, gearboxes not only transmit power but also convert speed into torque. The torque ratio of a gear train, also known as its mechanical advantage, is determined by the gear ratio. The energy generated from any power source has to go through the internal components of the gearbox in the form of stresses or mechanical pressure on the gear elements. Therefore, a critical aspect in any gearbox design comprises engineering the proper contact between the intermeshing gear elements. These contacts are typically points or lines on the gear teeth where the force concentrates. Because the area of contact points or lines in conventional gear trains is typically very low and the amount of power transmitted is considerable, the resultant stress along the points or lines of contact is in all cases very high. For this reason, designers of gearbox devices typically concentrate a substantial portion of their engineering efforts in creating as large a line of contact as possible or create as many simultaneous points of contact between the two intermeshed gears in order to reduce the resultant stress experienced by the respective teeth of each gear.

Another important consideration in gearbox design is minimizing the amount of backlash between intermeshing gears. Backlash is the striking back of connected wheels in a piece of mechanism when pressure is applied. In the context of gears, backlash (sometimes called lash or play) is clearance between mating components, or the amount of lost motion due to clearance or slackness when movement is reversed and contact is re-established. For example, in a pair of gears backlash is the amount of clearance between mated gear teeth.

Theoretically, backlash should be zero, but in actual practice some backlash is typically allowed to prevent jamming. It is unavoidable for nearly all reversing mechanical couplings, although its effects can be negated. Depending on the application it may or may not be desirable. Typical reasons for requiring backlash include allowing for lubrication, manufacturing errors, deflection under load and thermal expansion. Nonetheless, low backlash or even zero backlash is required in many applications to increase precision and to avoid shocks or vibrations. Consequently, zero backlash gear train devices are in many cases expensive, short lived and relatively heavy.

Weight and size are yet another consideration in the design of gearboxes. The concentration of the aforementioned stresses on points or lines of contact in the intermeshed gear trains necessitates the selection of materials that are able to resist those forces and stresses. However, those materials are oftentimes relatively heavy, hard and difficult to manufacture.

Thus, a need exists for an improved and more lightweight gearbox mechanism, which is capable of handling high stress loads in points or lines of contact between its intermeshed gears. Further, a need exists for an improved and more lightweight gearbox mechanism having low or zero backlash that is less expensive to manufacture and more reliable and durable.

### BRIEF SUMMARY

The present disclosure is related to a gear box mechanism having a carrier configured to house a plurality of gear blocks, a retainer cam, a cam shaft, and a plurality of cam followers. The gear blocks can interact with a ring gear allowing an output to be driven. The carrier can be housed within a first lid, and a second lid. The plurality of gear blocks can be driven by the cam shaft that has a plurality of cam pathways along an outer circumferential surface of the cam shaft. Additionally, the retainer cam has a retention pathway along an inner surface of the retainer cam. One or more of the plurality of cam followers engage with the cam pathways and the retention pathway, allowing the plurality of gear blocks to be actuated based on the position of the plurality of cam followers along the retention pathway and the cam pathways.

Thus, in one aspect, the present disclosure is directed to a gear box mechanism having a carrier configured to house portions of the gear box mechanism. The carrier can be a cylindrical shape having an input section, a gear block section, and an output section. The input section can define a central opening that passes through the carrier's length may be surrounded by an input section wall that at one end has at least one mounting aperture that allow for engagement with at least one fastener. The output section of the carrier may define the central opening that passes through the carrier's length, that is surrounded by an output section wall that at one end has at least one securing aperture that allows for engagement with at least one fastener.

The gear block section can define a central opening that passes through the carrier's length, the central opening can be surrounded by a block section wall that comprises at least one gear block opening being generally rectangular with rounded corners that passes completely through the block section wall, and on the inner edge of the block section wall at opposing corners of the at least one gear block opening there is a right angle recess that extends a portion of the way through the block section wall.

An input shaft with a plurality of cam pathways formed along the circumferential surface of the input shaft can interact with a set of cam followers that are coupled to a gear block that has a set of gear teeth opposite from where the set of com followers are coupled. The gear block can engage with a ring gear that is circular and defines a central aperture with a set of gear teeth along the inner circumference that engages with the gear block. A set of lids are coupled to the ring gear to house these components.

A retention cam that is circular with an outer wall that is perpendicular to a coupling surface and has a retention pathway along its inner surface can engage with the cam followers as well.

Other aspects, embodiments and features of the present disclosure will become apparent from the following detailed description when considered in conjunction with the accompanying figures. In the figures, each identical, or substantially similar component that is illustrated in various figures is represented by a single numeral or notation. For purposes of clarity, not every component is labeled in every figure. Nor is every component of the disclosure shown where illustration is not necessary to allow those of ordinary skill in the art to understand the disclosure.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1A is a front perspective view of a gearbox.

FIG. 1B is a rear perspective view of the gearbox.

FIG. 1C is a side view of the gearbox.

FIG. 2 is a front perspective view of an output flange.

FIG. 3 is a front perspective view of a input side lid.

FIG. 4A is a front perspective internal view of a gearbox.

FIG. 4B is a rear perspective internal view of the gearbox.

FIG. 5 is an exploded view of the input seal, flange, and input bearing.

FIG. 6 is a perspective view of the main body.

FIG. 7 is a rear internal view of the gearbox.

FIG. 8 is an exploded view of the ring gear and seals.

FIG. 9 is a perspective view of the carrier and internal gearing mechanisms.

FIG. 10 is a perspective view of the carrier.

FIG. 11A is a front perspective view of the internal gearing mechanisms.

FIG. 11B is a rear perspective view of the internal gearing mechanisms.

FIG. 11C is a side view of the internal gearing mechanisms.

FIG. 12A is an exploded view of the internal gearing mechanisms with gear blocks removed.

FIG. 12B is an exploded view of the internal gearing mechanisms with gear blocks removed.

FIG. 13 is a perspective view of the retention cam.

FIG. 14A is a rear view of the gearblock and cam follower assembly.

FIG. 14B is a top view of the gearblock and cam follower assembly.

FIG. 14C is a front view of the gearblock and cam follower assembly.

FIG. 14D is a side view of the gear block and cam follower assembly.

FIG. 15A is a first side view of the input cam shaft.

FIG. 15B is a second side view of the input cam shaft.

FIG. 15C is a top view of the input cam shaft.

FIG. 15D is a bottom view of the input cam shaft.

### DETAILED DESCRIPTION

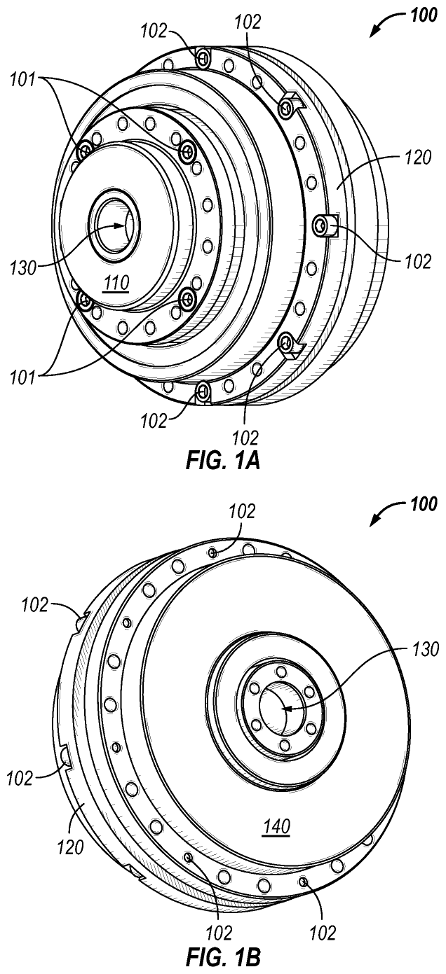

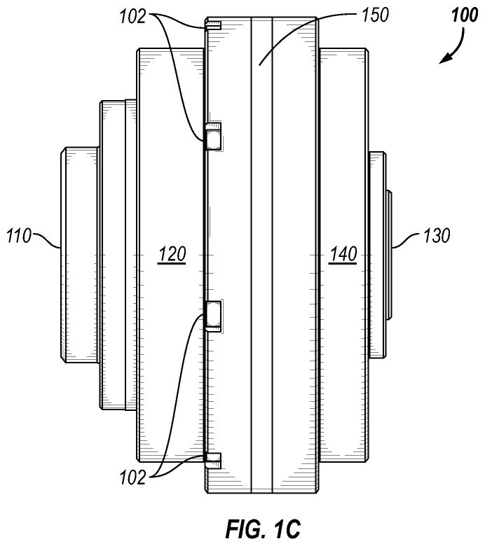

Embodiments of the disclosure will now be described. FIG. 1A is a front perspective view illustration of a gearbox 100. The gearbox 100 can include an output flange 110, a main body 120, an input cam shaft 130, a lid 140, and/or a ring gear 150. In at least one embodiment, the output flange 110, a main body 120, an input cam shaft 130, a lid 140, and/or a ring gear 150 can be considered a concentric system. The main body 120, lid 140, and/or ring gear 150 may be coupled with a fastener 101. In at least one example, the main body 120 may be referenced as a second lid, with lid 140 being referenced as a first lid. The fastener(s) 101 can include any number of devices and/or mechanisms that allow for the securing of multiple pieces. In some examples, an aperture (not illustrated) may be threaded or smooth. A threaded aperture is one that allows for the securing of a fastener such as but not limited to a bolt or screw through a helical pattern that can extend from one end to a specified point on the fastener, while a smooth bore of an aperture can allow for a fastener to pass without any securing action.

A gearing mechanism (not illustrated) may engage with an input cam shaft 130 that can rotate about a central axis. In at least one embodiment, the central axis may pass through a central aperture defined by the input cam shaft 130. The output flange 110 may be concentrically located with the input cam shaft 130. In at least one embodiment, the output flange 110 can be coupled to an internal component of the gearing mechanism (not illustrated) using a fastener(s) 102.

FIG. 1B is a rear perspective view illustration of a gearbox 100. In at least one embodiment, the gearbox 100 can include a main body 120, an input cam shaft 130, a lid 140, and a ring gear 150. The main body 120, ring gear 150, and/or the lid 140 can be utilized to surround and/or contain a gearing mechanism (not illustrated) that can interact and/or engage with the input cam shaft 130. A set of fastener(s) 102 may be utilized to couple the main body 120, ring gear 150, and/or the lid 140 in a manner that allows for a securing of the main body 120, ring gear 150, and/or the lid 140 to one another. For example, the main body 120, ring gear 150, and/or the lid 140 may have coupling apertures that may be threaded or smooth. In at least one example, the main body 120 and the lid 140 may have threaded coupling apertures while the ring gear 150 can have a smooth coupling aperture(s). In other examples, any of the main body 120, ring gear 150, and/or the lid 140 may have a threaded or smooth coupling aperture.

In at least one example, the lid 140 may include central aperture that allows for a portion of the input cam shaft 130 to pass through, and/or be coupled to an input device such as but not limited to a motor, rotational device, or other mechanical system capable of movement.

FIG. 1C is a side view illustration of a gearbox 100. In at least one embodiment, the gearbox 100 can include an output flange 110, main body 120, an input cam shaft 130, a lid 140, and a ring gear 150. The output flange 110, main body 120, ring gear 150, and/or the lid 140 can be utilized to surround and/or contain a gearing mechanism (not illustrated) that can interact and/or engage with the input cam shaft 130. A set of fastener(s) 102 may be utilized to couple the main body 120, ring gear 150, and/or the lid 140 in a manner that allows for a securing of the main body 120, ring gear 150, and/or the lid 140 to one another. For example, the main body 120, ring gear 150, and/or the lid 140 may have coupling apertures that may be threaded or smooth. In at least one example, the main body 120 and the lid 140 may have threaded coupling apertures while the ring gear 150 can have a smooth coupling aperture(s). In other examples, any of the main body 120, ring gear 150, and/or the lid 140 may have a threaded or smooth coupling aperture.

In at least one example, the lid 140 may include a central aperture that allows for a portion of the input cam shaft 130 to pass through, and/or be coupled to an input device such as but not limited to a motor, rotational device, or other mechanical system capable of movement. The output flange 110 may allow for an output rotation to be imparted onto an output device (not illustrated). The output flange 110 can couple to the gearing mechanism to allow for the rotation of the input through the gearing mechanism to be imparted to the output device.

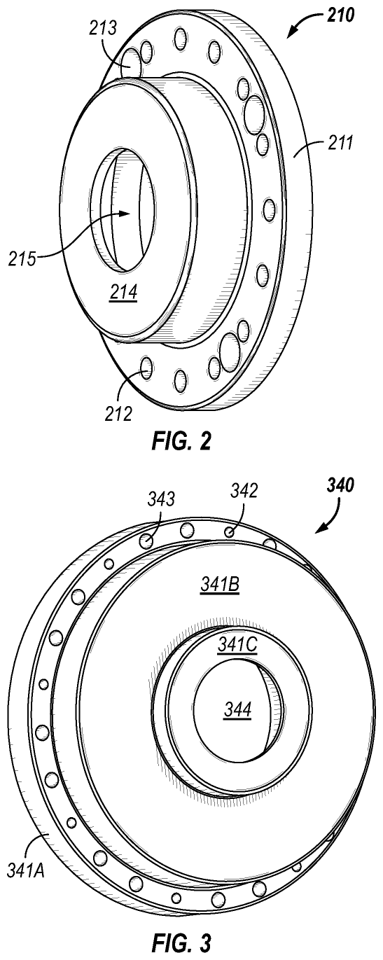

FIG. 2 is a front perspective view illustration of an output flange 210. The output flange 210 is general a cylindrical disc shape that can have multiple sections, such as but not limited to a mounting section 211 and/or a recessed section 214. In at least one example, the mounting section 211 is the main point of interactions for the output flange 210 having a shelf or extension that extends radially from the recessed section 214. The recessed section 214 in at least one example, may be extending outward from the gearbox (not illustrated) and/or create a recessed void to receive portions of a gearing mechanism (not illustrated) or other portions of a gearbox (not illustrated).

The mounting section 211 of the output flange 210 may include multiple apertures that allow for engagement of the output flange 210 with other devices, mechanisms, and/or systems. For example, the mounting section 211 can include one or more connecting apertures 212, and/or one or more mounting apertures 213. In some examples, the connecting aperture(s) 212 and mounting aperture(s) 213 may be the same size, type, and/or style. However, in a least one embodiment the mounting aperture(s) 213 can be larger than the connecting aperture(s) 212. The mounting aperture(s) 213 can allow for fastener(s) (not illustrated) to secure the output flange 210 to the gearbox (not illustrated) or portions of the gearbox. In at least one example, the mounting aperture(s) 213 may allow for the fasteners to be in line or below the surface level of the mounting section 211 when fully engaged and/or secured. Similarly, the connecting aperture(s) 212 can allow for fastener(s) (not illustrated) to secure and/or connect the output of the gearbox (not illustrated) to an output device, system, and/or mechanism. In some examples, a central aperture 215 may be found centrally located on the planar surface of the recessed section 214 and/or mounting section 211.

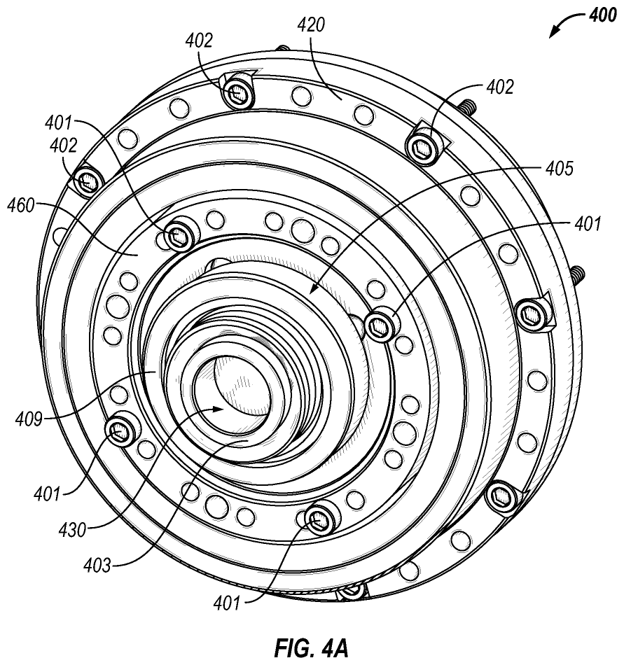

FIG. 3 is a perspective view illustration of a lid 340. In at least one embodiment, the lid 340 can include a mounting section 341A, a receiving section 341B, and/or an input section 341C. These multiple sections 341A, 341B, and/or 341C can allow the lid 340 to contain, and/or interact with components of the gearbox and/or gearing mechanism. For example, the lid 340 may interact with an input cam shaft (not illustrated), and allow for its interconnection with other input mechanisms, devices, and/or systems. The receiving section 341B may include a receiving void (not illustrated) that allows portions of the gearbox and/or gearing mechanism to rest against, or interact with the lid 340. The receiving section 341B can be recessed and/or extended outward from the gearbox, and/or mounting section 341A. The input section 341C may be recessed from the mounting section 341A and/or receiving section 341B, similar to the receiving section 341B, and allow for interactions or engagement with an input cam shaft (not illustrated) or other input devices, systems, or mechanisms.

In at least one example, the mounting section 341A of the lid 340 may include multiple apertures that allow for engagement of the lid 340 with other devices, mechanisms, and/or systems. For example, the mounting section 341A can include one or more connection apertures 342, and/or one or more mounting apertures 343. In some examples, the connection aperture(s) 342 and mounting aperture(s) 343 may be the same size, type, and/or style. However, in a least one embodiment the mounting aperture(s) 343 can be larger than the connecting aperture(s) 342. The connection aperture(s) 342 can allow for fastener(s) (not illustrated) to secure the lid 340 to the gearbox (not illustrated) or portions of the gearbox. Similarly, the mounting aperture(s) 343 can allow for fastener(s) (not illustrated) to secure and/or connect the gearbox (not illustrated) to an other devices, systems, and/or mechanisms. In some examples, a central aperture 344 may be found centrally located on the planar surface of the receiving section 341B, and/or the input section 341C.

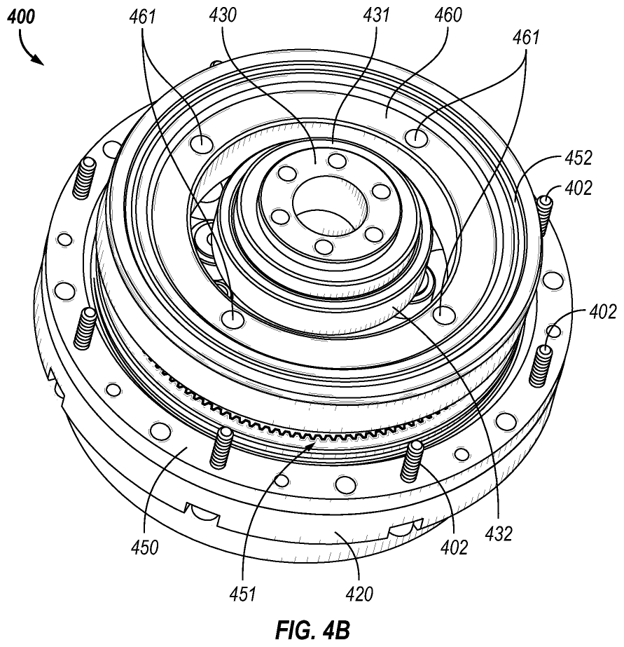

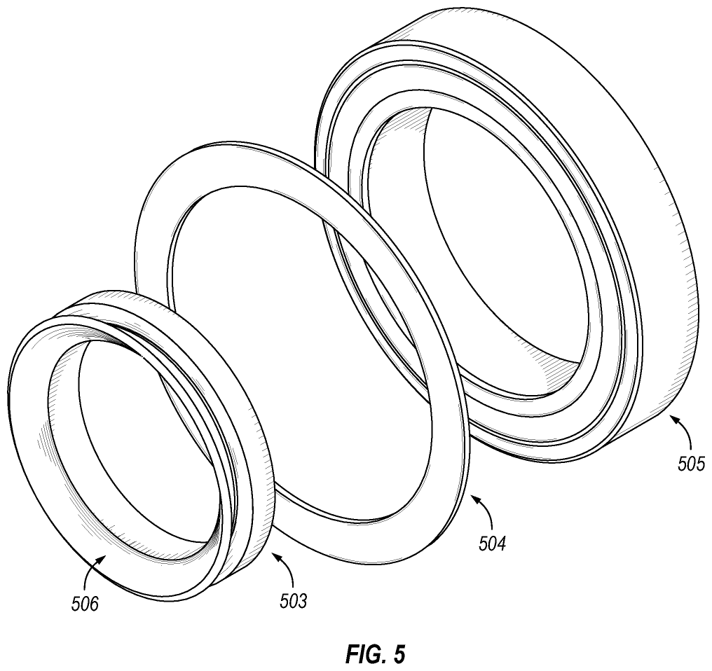

FIG. 4A is an internal view illustration of a gearbox 400 from an output side (with the output flange removed). The gearbox 400 can house and/or contain multiple components or units that allow for the transfer of rotational energy or power from an input to an output. For example, the gearbox 400 may contain and/or interact with a seal 403, spring 404, and/or a bearing 405 each of which may interact or engage with an input cam shaft 430. In at least one example, the seal 403 is utilized to prevent materials from getting within the inner workings of the gearbox 400 and/or bearing 405. The spring 404 may be utilized to ensure that biasing occurs between various portions and/or components of the gearbox 400. For example, the spring 404 may be utilized to ensure the seal 403 engages with the proper components or portions of the gearbox 400 to prevent materials from entering and causing issues or damage due to the tight tolerances.

The input cam shaft 430 may be surrounded by a gearing mechanism (not illustrated) and a carrier 460 that is utilized to house and/or generate movement. In at least one embodiment, the carrier 460 can rotate based on the engagement and/or interaction of the gearing mechanism with the input cam shaft 430. Additional bearings, rollers, or other devices or mechanisms that can allow for freedom of rotation may be placed between the carrier 460, and/or the main body 420. It would be understood that other portions of the gearbox 400 may interact with the carrier 460 and/or other portions of the gearbox 400. The carrier 460 may be coupled to an output flange (not illustrated) through fastener(s) 402, while the main body 420 may be coupled to other portions of the gearbox 400 through fastener(s) 402.

FIG. 4B is an internal view illustration of a gearbox 400 from the input side (with the lid removed). Within the gearbox 400, a gearing mechanism (numbered and illustrated in later figures) may be utilized to translate, and/or impart a rotational energy or power from an input to an output. The gearing mechanism can interact or engage with a ring gear 450 that can include a set of gear teeth 451. The set of gear teeth 451 can allow for the gearing mechanism to engage and/or move based engagement with the ring gear 450. A bearing 452 may be present surrounding a carrier 460. In at least one example, the carrier 460 may be considered part of the gearing mechanism, while in other examples, the carrier 460 surrounds the gearing mechanism. The carrier 460 may include a set of rotation pins 461 that allow for the gearing mechanism to move about within a defined space and/or track. In some examples, the bearing 452 may interact with a lid or other containment portion of gearbox 400, to allow for the containment of the gearbox 400. The bearing 452 may also be a roller or a set of ball bearings that allow for rotational freedom of movement. Similarly, the input cam shaft 430 can engage with and/or interact with a bearing or roller 424 and/or a seal 431. The internal portions of the gearbox 400, can be housed within a main body 420, a ring gear 450, and/or a lid (not illustrated). The main body 420, ring gear 450, and/or lid (not illustrated) may be coupled and/or secured together through a set of fastener(s) 402.

FIG. 5 is an exploded view illustration of a seal 503, spring 504, and/or bearing 505. The seal 503, spring 504, and/or bearing 505 may be utilized as part of an engagement system for an input cam shaft (not illustrated), and/or may be utilized throughout a gearbox individually or in combination. The seal 503 can be utilized to prevent materials from getting within the inner workings of the gearbox and/or bearing 505. The bearing 505 may be design with tolerances that if a grain of sand enters it can cause significant damage to the bearing 505. The bearing 505 can be any bearing, set of ball bearings, or roller(s) that allow for freedom of rotational motion. The spring 504 may be utilized to ensure that there a biasing occurs between various portions and/or components of the gearbox. For example, the spring 504 may be utilized to ensure the seal 503 engages with the proper components or portions of the gearbox to prevent materials from entering and causing issues or damage due to the tight tolerances. In at least one example the spring 504 is biased (meaning a force is applied against the bearing 505 allow the seal 503 to be forced against a lid or other stationary object to prevent material from entering the bearing 505 or the area around it.

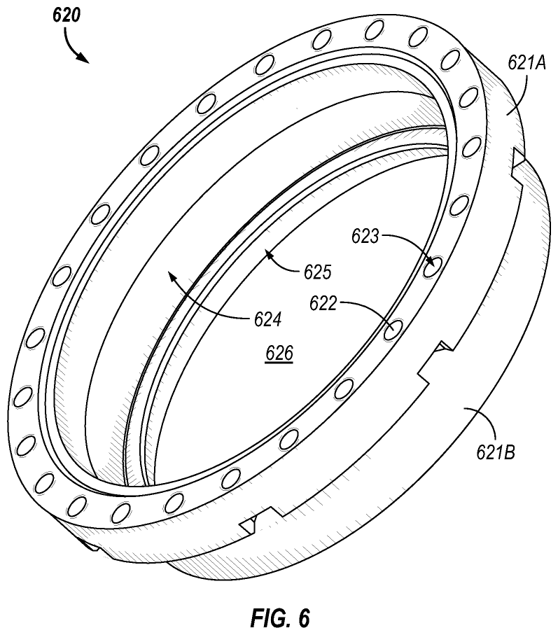

FIG. 6 is a rear perspective view illustration of a main body 620. The main body 620 can be a portion of the gearbox (not illustrated) that assists in housing and/or containing a gearing mechanism (not illustrated). The main body 620 can have multiple sections, including but not limited to a mounting section 621A, and/or receiving section 621B. In at least one example, the mounting section 621A can allow for the mounting and/or coupling of the main body 620 to other portions of a gearbox. The mounting section 621A can have engagement apertures 622 and/or mounting apertures 623. The engagement apertures 622 can allow for the main body 620 to be coupled to other mechanisms, systems, and/or devices that allow for rotational or stationary forces to be applied. The mounting apertures 623 may be utilized to secure the main body 620 to other portions of the gearbox, such as but not limited a ring gear (not illustrated), a lid (not illustrated), and/or other portions of the gearbox. The mounting section 621A may include a step or ledge 625 that allows for the mounting apertures 623 and/or engagement apertures 622 to pass through to allow for securing and/or coupling.

The receiving section 621B can allow for portions of a gearing mechanism or other portions of the gearbox to be received and/or contained. A receiving void 624 can be defined by the main body 620. In at least embodiment, the receiving void 624 is defined by the mounting section 621A and/or receiving section 621B. Similarly, a central aperture 626 may be defined by the main body 620, and/or the mounting section 621A and/or receiving section 621B. In at least one example, the central aperture 626 can allow for portions of the gearing mechanism, and/or other portions of the gearbox to be accessed.

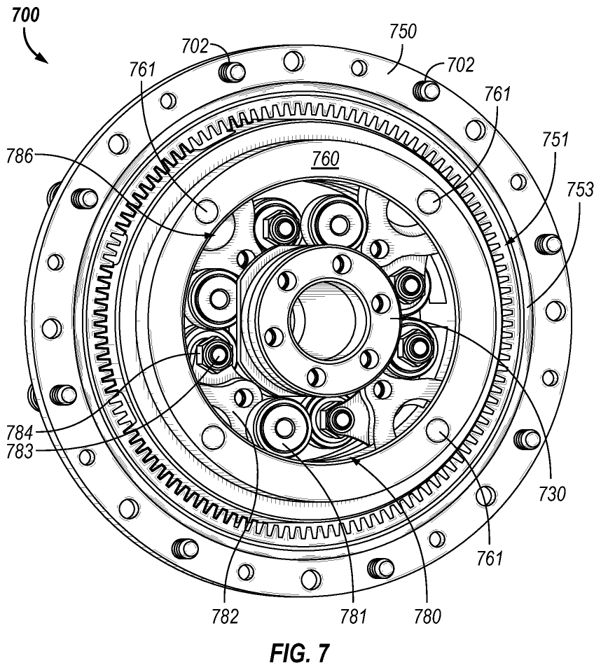

FIG. 7 is a perspective internal view illustration of a gearbox 700. The gearbox 700 can have multiple portions, with some such as but not limited to the ring gear 750 and/or fastener(s) 702 that can be viewed externally, while others such as but not limited to an input cam shaft 730, carrier 760, and/or gearing mechanism 780 may be seen in internally. In at least one example, the ring gear 750 can be secured and/or coupled to other portions of the gearbox 700 via the fastener(s) 702. The ring gear 750 can have a set of gear teeth 751 that allows for engagement with the gearing mechanism 780.

In at least one embodiment, the carrier 760 can surround the gearing mechanism 780. The carrier 760 allows the gearing mechanism 780 to move in relation to an input cam shaft 730. As the input cam shaft 730 causes the gearing mechanism to move in a two dimensional manner that can shift radially as well as rotationally. The carrier 760 can have a set of rotation pins 761 that allow the gear block 782 to move based on interactions of the rotation pins 761. The gear block 782 can have a movement void 785 that can receive the rotation pin(s) 761. In at least one example, the gear block 782 can have two or more cam follower(s) 781 that have an engagement pin 783 that can engage with a securing mechanism 784.

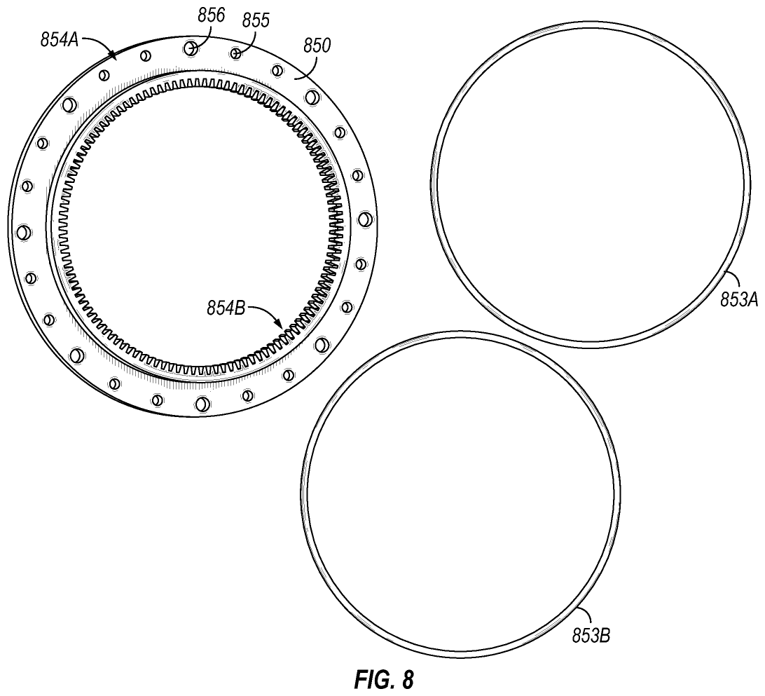

FIG. 8 is an exploded view illustration of a ring gear 850 and seal(s) 853A/853B. The ring gear 850 can have one or more seals 853A/853B. The seal(s) 853A/853B prevents material from entering the area around the gearing mechanism and/or carrier (not illustrated). In at least one embodiment, the ring gear 850 can have a mounting section 854A and/or engagement section 854B. The mounting section 854A can include a set of connecting aperture(s) 855, and/or a set of mounting aperture(s) 856. The engagement section 854B can include a set of gear teeth 851 that allow for engagement with the gearing mechanism. In at least one embodiment, the engagement section 854B can be taller than the mounting section 854A, and at the inflection point are where the seal(s) 853A/854B can engage to prevent materials from entering the gearing mechanism (not illustrated).

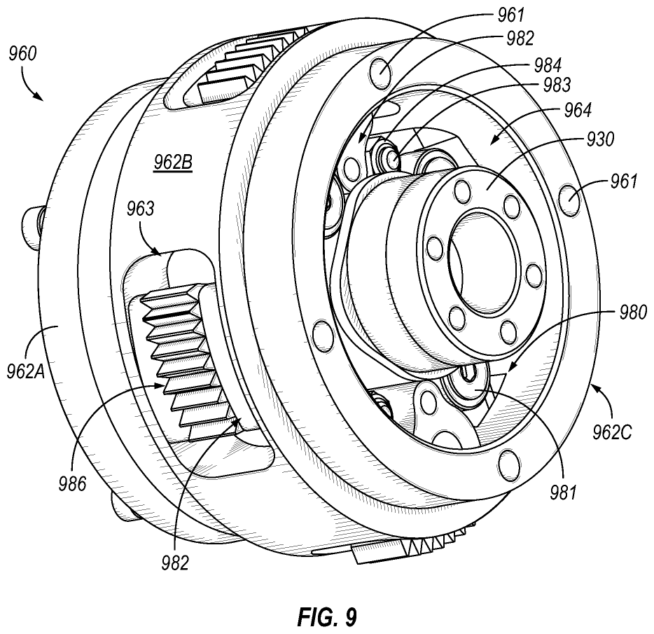

FIG. 9 is a perspective view illustration of a carrier 960, input cam shaft 930, and a gearing mechanism 980. In at least one embodiment, the carrier 960 can have a set of gearing aperture(s) 963 that allow for a gear block 982 of the gearing mechanism 980 to pass through. The carrier 960 can also have multiple sections, such as but not limited to, an engagement section 962A, a gearing section 962B, and/or a rotational section 962C. In at least one example, the engagement section 962A allows for engagement with other devices, mechanisms, and/or portions of the gearbox (not illustrated). The gearing section 962B allows for the set of gearing aperture(s) 963. The rotational section 962C allows for bearings, and/or rollers to engage with the carrier 960 to ease rotational movement. The carrier 960 can have a central aperture 964 that allows for the input cam shaft 930 and/or the gearing mechanism 980.

In at least one example, the carrier 960 can include one or more rotational pin(s) 961. The rotational pin(s) 961, can interact with the gear block 982 to allow for the two-dimensional movement of the gear block 982. The carrier 960 can have a gearing aperture(s) 963 that are larger than the gear block 982 to allow for the movement of the gear block 982. The movement of the gear block 982 can be caused by the cam follower(s) 981 can interact with the input cam shaft 930, allowing the gear teeth 986 of the gear block 982 to engage with a ring gear (not illustrated). In at least one example, the cam follower(s) 981 can be engaged with the gear block 982 with an engagement pin 983, which can be engaged with a securing mechanism 984.

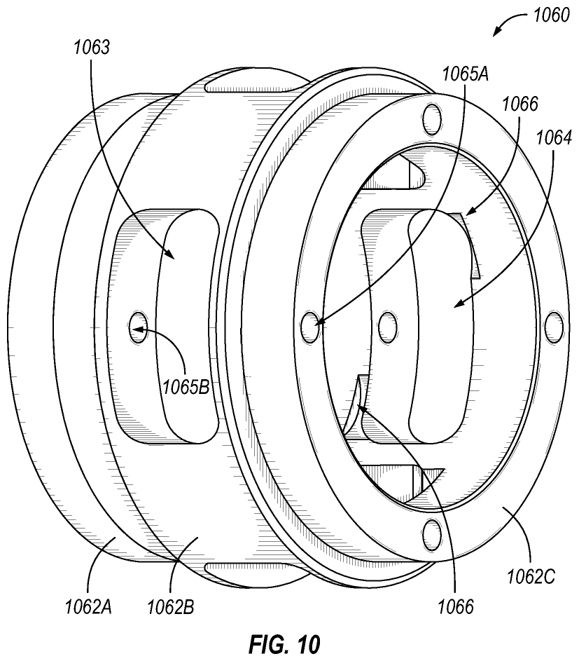

FIG. 10 is a perspective view illustration of a carrier 1060. In at least one embodiment, the carrier 1060 can be a cylindrical shape having multiple sections, and/or apertures. The cylindrical shape of the carrier 1060 may allow for the defining a central aperture 1064 can pass through the radial center of the carrier 1060. For example, the carrier 1060 may have an engagement section 1062A, a gearing section 1062B, and/or a rotational section 1062C. In at least one example, the engagement section 1062A can allow for the carrier 1060 to be engaged with other devices, systems, or mechanisms such as but not limited to an output device (not illustrated) and/or an output flange (not illustrated). Similarly, the rotational section 1062C can allow for engagement of the carrier 1060 by bearings, rollers, sets of ball bearings, and/or other devices, mechanisms, or systems that allow for freedom of rotation. The gearing section 1062B may extend and/or protrude radially from the carrier 1060 in some examples, and allow for one or more gearing aperture(s) 1063 to pass through the wall of cylinder portion (gearblock section 1062B) of the carrier 1060. The gearing aperture(s) 1063 can also have a recessed pivot void 1066 that can be found on opposing corners of the inner side of the carrier 1060. These recessed pivot void(s) 1066 allow for a gearing mechanism to move with relative freedom, and/or provide limits that can cause the gearing mechanism to behave in a defined or desired manner. In some examples, the recessed pivot void 1066 may be rectangular in shape while in other examples, the recessed pivot void 1066 can have other shapes and/or volumes that allows for interaction with a gearing mechanism (not illustrated). In at least one embodiment, the carrier 1060 may include a rotational pin aperture 1065A that allows for a rotational pin (not illustrated) to be passed through, similarly the gearing aperture 1063 can be passed through with the rotational pin and the received on the opposing side of the gearing aperture 1063 by a rotational pin receiving point 1065B. The rotational pin receiving point 1065B may be of a specified depth to allow the rotational pin (not illustrated) to be flush or below the surface of the carrier 1060 when the rotational pin is at its proper setting and/or position. Additionally, in some examples, the rotational pin receiving point 1065B may have glue, fastener(s), friction, and/or other mechanism, devices, or system to hold the rotation pin in place.

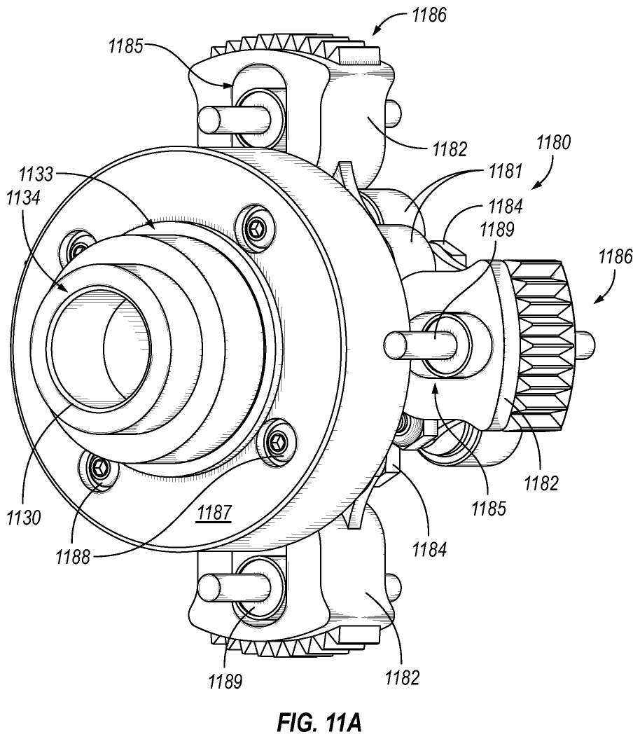

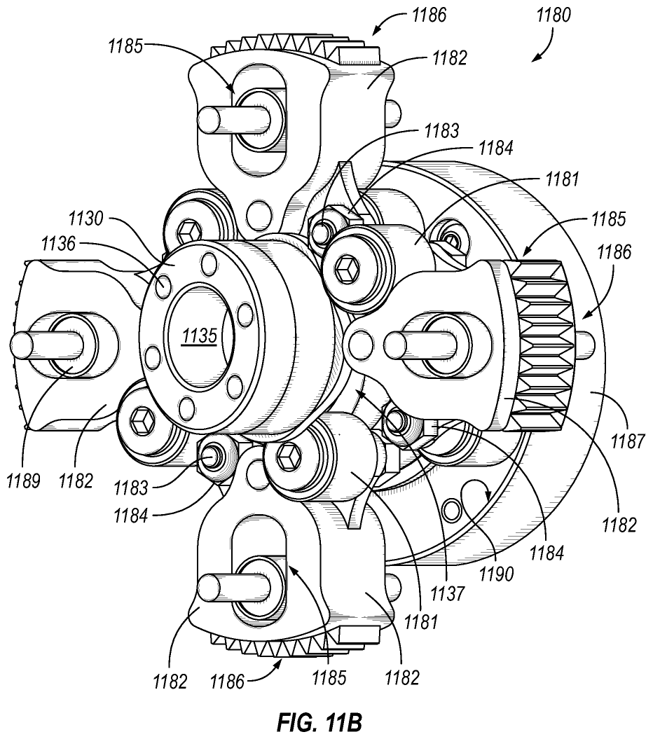

FIG. 11A is a front perspective view illustration of an input cam shaft 1130 and a gearing mechanism 1180. The input cam shaft 1130 can rotate based on the rotations of an input device, system, or mechanism (not illustrated). As the input cam shaft 1130 rotates it interacts with the gearing mechanism 1180 to cause movements of the gear block(s) 1182. The input cam shaft 1130 can have multiple sections and/or surfaces, including but not limited to a bearing surface or section 1133 that allows for bearings, or rollers or other devices, systems, or mechanisms that allow for freedom of rotation to be utilized in a manner that allows the input cam shaft to freely rotate about an axis passing through its length. There can also be a buffer section 1134 that can engaged with other portions of a gearbox (not illustrated), or an input or output device, system, or mechanism (not illustrated). The input cam shaft 1130 may also couple with a retention cam 1187 through one or more fastener(s) 1188.

The retention cam 1187 can interact and/or engage with one or more cam followers 1181 of the gearing mechanism 1180. The gearing mechanism 1180 may include a gear block 1182 that can have, in at least one example, an engagement pin 1183 (in other examples may be referenced as a rotation pin for the carrier (not illustrated)) that passes through a movement void 1185, and/or a void bearing 1189. In at least one example the void bearing 1189 may alternatively be a roller or set of ball bearings that allow the engagement pin 1183 to move with the movement void 1185 in a specified manner. The gear block 1182 may include a set of gear teeth 1186 that allow for interaction with a ring gear or other set of opposing gear teeth that can assist in facilitating movement.

FIG. 11B is a rear perspective view illustration of an input cam shaft 1130 and a gearing mechanism 1180. The input cam shaft 1130 can rotate based on the rotations of an input device, system, or mechanism (not illustrated). The input cam shaft 1130 can include a central aperture 1135 and/or mounting aperture(s) 1136. In at least one example, the mounting aperture(s) 1136 can be utilized to couple the input cam shaft 1130 to an input device, mechanism or system (not illustrated). This input device, mechanism, or system (not illustrated) can impart a rotational movement on the input cam shaft 1130 that causes its rotation and also the rotation of the cam pathway(s) 1137. These cam pathways 1137 can interact with the cam follower(s) 1181 of the gearing mechanism 1180. As the cam follower(s) 1181 move in correspondence to the cam pathway(s) 1137 they can impart movement in two dimensions on the gear block(s) 1182. Similarly, one or more of the cam follower(s) 1181 may follow an internal or retention pathway 1190 of the retention cam 1187.

The retention cam 1187 can interact and/or engage with one or more cam followers 1181 of the gearing mechanism 1180. The gearing mechanism 1180 may include a gear block 1182 that can have, in at least one example, an engagement pin 1183 (in other examples may be referenced as a rotation pin for the carrier (not illustrated)) that passes through a movement void 1185, and/or a void bearing 1189. In at least one example the void bearing 1189 may alternatively be a roller or set of ball bearings that allow the engagement pin 1183 to move with the movement void 1187 in a specified manner. The gear block 1182 may include a set of gear teeth 1186 that allow for interaction with a ring gear or other set of opposing gear teeth that can assist in facilitating movement. Additionally, the cam follower(s) 1181 may be secured with a securing mechanism 1184. In at least one example, the securing mechanism 1184 may include a both or other threaded device that engages with a nut or other securable device.

FIG. 11C is side view illustration of an input cam shaft 1130 and a gearing mechanism 1180. The input cam shaft 1130 can rotate based on the rotations of an input device, system, or mechanism (not illustrated). As the input cam shaft 1130 rotates it interacts with the gearing mechanism 1180 to cause movements of the gear block(s) 1182. The input cam shaft 1130 can have multiple sections and/or surfaces, including but not limited to a bearing surface or section that allows for bearings 1132, or rollers or other devices, systems, or mechanisms that allow for freedom of rotation to be utilized in a manner that allows the input cam shaft to freely rotate about an axis passing through its length. The input cam shaft 1130 may also couple with a retention cam 1187 through one or more fastener(s) 1188.

The input cam shaft 1130 can include a central aperture 1135 and/or mounting aperture(s) 1136. In at least one example, the mounting aperture(s) 1136 can be utilized to couple the input cam shaft 1130 to an input device, mechanism or system (not illustrated). This input device, mechanism, or system (not illustrated) can impart a rotational movement on the input cam shaft 1130 that causes its rotation and also the rotation of the cam pathway(s) 1137. These cam pathways 1137 can interact with the cam follower(s) 1181 of the gearing mechanism 1180. As the cam follower(s) 1181 move in correspondence to the cam pathway(s) 1137 they can impart movement in two dimensions on the gear block(s) 1182.

The retention cam 1187 can interact and/or engage with one or more cam followers 1181 of the gearing mechanism 1180. The gearing mechanism 1180 may include a gear block 1182 that can have, in at least one example, an engagement pin 1183 (in other examples may be referenced as a rotation pin for the carrier (not illustrated)) that passes through a movement void (not illustrated), and/or a void bearing (not illustrated). The gear block 1182 may include a set of gear teeth 1186 that allow for interaction with a ring gear or other set of opposing gear teeth that can assist in facilitating movement. Additionally, the cam follower(s) 1181 may be secured with a securing mechanism 1184. In at least one example, the securing mechanism 1184 may include a threaded device that engages with a nut or other securable device and/or an engagement pin 1183. A rotational pin 1161 may also be present for engagement with a carrier (not illustrated).

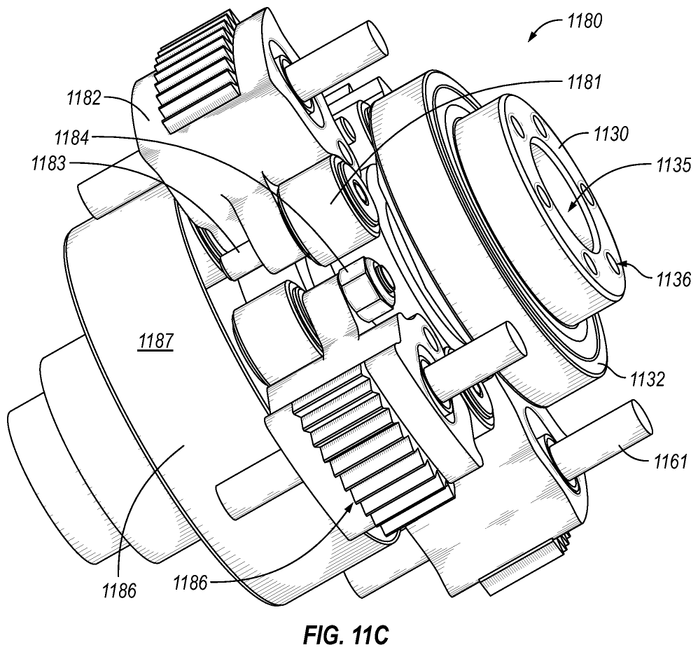

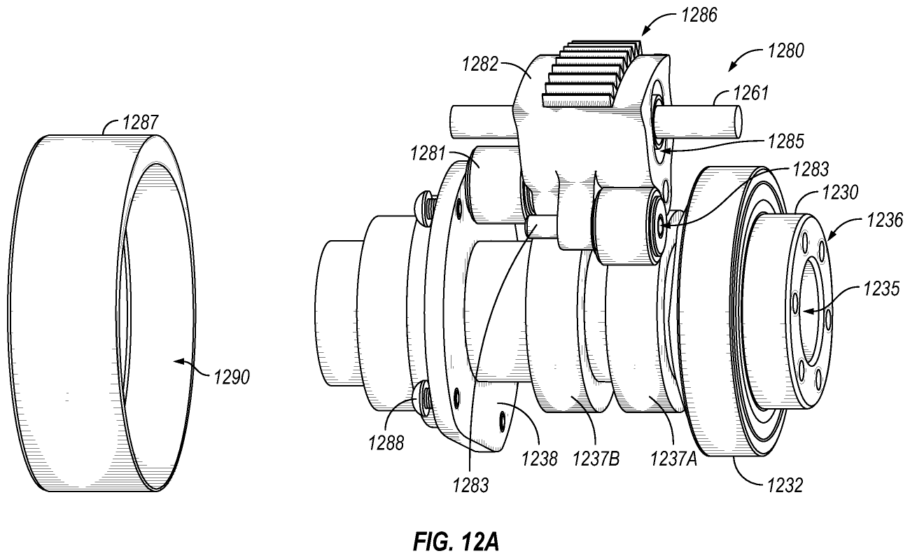

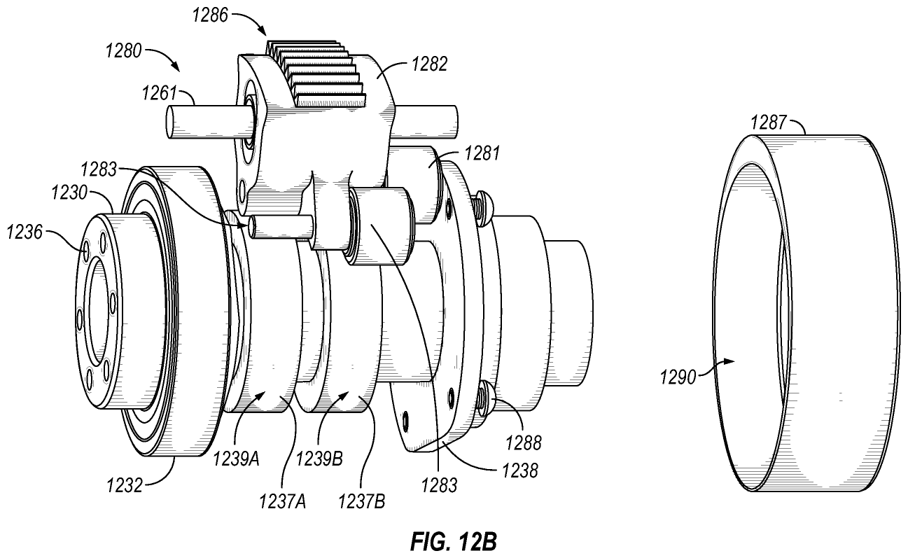

FIG. 12A is a partial side view illustration of an input cam shaft 1230, a partial gearing mechanism 1280, and a retention cam 1287. The input cam shaft 1230 can rotate based on the rotations of an input device, system, or mechanism (not illustrated). As the input cam shaft 1230 rotates it interacts with the gearing mechanism 1280 to cause movements of the gear block(s) 1282. The input cam shaft 1230 can have multiple sections and/or surfaces, including but not limited to a bearing surface or section that allows for bearings 1232, or rollers or other devices, systems, or mechanisms that allow for freedom of rotation to be utilized in a manner that allows the input cam shaft to freely rotate about an axis passing through its length. The input cam shaft 1230 may also couple with a retention cam 1287 through one or more fastener(s) 1288. In at least one embodiment, the input cam shaft 1230 may also have a blocking wall 1238 that assists in keeping the gearing mechanism 1280 contained. In some examples, the blocking wall 1238 may also be utilized to prevent materials such as, but not limited to, sand, dirt or other materials from interacting with the gearing mechanism, and thus preventing possible damage to the gearing mechanism and/or gearbox (not illustrated).

The input cam shaft 1230 can include a central aperture 1235 and/or mounting aperture(s) 1236. In at least one example, the mounting aperture(s) 1236 can be utilized to couple the input cam shaft 1230 to an input device, mechanism or system (not illustrated). This input device, mechanism, or system (not illustrated) can impart a rotational movement on the input cam shaft 1230 that causes its rotation and also the rotation of the cam pathway(s) 1237A/1237B. These cam pathways 1237A/1237B can interact with the cam follower(s) 1281 of the gearing mechanism 1280. As the cam follower(s) 1281 move in correspondence to the cam pathway(s) 1237A/1237B they can impart movement in two dimensions on the gear block(s) 1282.

The retention cam 1287 can interact and/or engage with one or more cam followers 1281 of the gearing mechanism 1280. The gearing mechanism 1280 may include a gear block 1282 that can have, in at least one example, an engagement pin 1283 (in other examples may be referenced as a rotation pin for the carrier (not illustrated)) that passes through a movement void (not illustrated), and/or a void bearing (not illustrated). The gear block 1282 may include a set of gear teeth 1286 that allow for interaction with a ring gear or other set of opposing gear teeth that can assist in facilitating movement. Additionally, the cam follower(s) 1281 may be secured with a securing mechanism 1284. In at least one example, the securing mechanism 1284 may include a threaded device that engages with a nut or other securable device and/or an engagement pin 1283. A rotational pin 1261 may also be present for engagement with a carrier (not illustrated).

As the input cam shaft 1230 rotates it causes the cam pathways 1237A/1237B to rotate. Similarly, the retention pathway 1290 of the retention cam 1287, rotates with the rotation of the input cam shaft 1230 since the retention cam 1287 is coupled to the input cam shaft 1230. As the cam follower(s) 1281 follow the various pathway(s) 1237A/1237B/1290 the gear block 1282 can have a rotational movement (as seen in the figure towards the sheet in a forward/backwards rotation, as well as in a radial direction to allow for the gear block 1282 to be put in a reset position. The reset position allows the gear block 1282 to reengage further along the ring gear (not illustrated).

FIG. 12B is a partial side view illustration of an input cam shaft 1230, a partial gearing mechanism 1280, and a retention cam 1287. The input cam shaft 1230 can rotate based on the rotations of an input device, system, or mechanism (not illustrated). As the input cam shaft 1230 rotates it interacts with the gearing mechanism 1280 to cause movements of the gear block(s) 1282. The input cam shaft 1230 can have multiple sections and/or surfaces, including but not limited to a bearing surface or section that allows for bearings 1232, or rollers or other devices, systems, or mechanisms that allow for freedom of rotation to be utilized in a manner that allows the input cam shaft to freely rotate about an axis passing through its length. The input cam shaft 1230 may also couple with a retention cam 1287 through one or more fastener(s) 1288. In at least one embodiment, the input cam shaft 1230 may also have a blocking wall 1238 that assisting in keeping the gearing mechanism 1280 contained. In some examples, the blocking wall 1238 may also be utilized to prevent materials such as, but not limited to sand, dirt or other materials from interacting with the gearing mechanism, and thus preventing possible damage to the gearing mechanism and/or gearbox (not illustrated).

The input cam shaft 1230 can include a central aperture 1235 and/or mounting aperture(s) 1236. In at least one example, the mounting aperture(s) 1236 can be utilized to couple the input cam shaft 1230 to an input device, mechanism or system (not illustrated). This input device, mechanism, or system (not illustrated) can impart a rotational movement on the input cam shaft 1230 that causes its rotation and also the rotation of the cam pathway(s) 1237A/1237B. These cam pathways 1237A/1237B can interact with the cam follower(s) 1281 of the gearing mechanism 1280. As the cam follower(s) 1281 move in correspondence to the cam pathway(s) 1237A/1237B they can impart movement in two dimensions on the gear block(s) 1282.

The retention cam 1287 can interact and/or engage with one or more cam followers 1281 of the gearing mechanism 1280. The gearing mechanism 1280 may include a gear block 1282 that can have, in at least one example, an engagement pin 1283 (in other examples may be referenced as a rotation pin for the carrier (not illustrated)) that passes through a movement void (not illustrated), and/or a void bearing (not illustrated). The gear block 1282 may include a set of gear teeth 1286 that allow for interaction with a ring gear or other set of opposing gear teeth that can assist in facilitating movement. Additionally, the cam follower(s) 1281 may be secured with a securing mechanism 1284. In at least one example, the securing mechanism 1284 may include a threaded device that engages with a nut or other securable device and/or an engagement pin 1283. A rotational pin 1261 may also be present for engagement with a carrier (not illustrated).

As the input cam shaft 1230 rotates it causes the cam pathways 1237A/1237B to rotate. The cam pathway 1237A may have a pathway extension 1239A, while cam pathway 1237B may have a pathway extension 1239B. These pathway extensions 1239A/1239B may extend radially outward from the input cam shaft, to cause a rise and/or fall, or a ramping effect for the cam pathway(s) 1237A/1237B. In at least one example, each of the cam pathway(s) 1237A/1237B may have one or more pathway extensions to assist in the movements of the gear block 1282. Similarly, the retention pathway 1290 of the retention cam 1287, rotates with the rotation of the input cam shaft 1230 since the retention cam 1287 is coupled to the input cam shaft 1230. As the cam follower(s) 1281 follow the various pathway(s) 1237A/1237B/1290 the gear block 1282 can have a rotational movement (as seen in the figure towards the sheet in a forward/backwards rotation, as well as in a radial direction to allow for the gear block 1282 to be put in a reset position. The reset position allows the gear block 1282 to reengage further along the ring gear (not illustrated).

FIG. 13 is a perspective view illustration of a retention cam 1387. The retention cam 1387 can be generally disc shaped with multiple section. For example, there can be the receiving section 1392A and/or pathway section 1392B that allows for a pathway wall 1392C to be defined. In at least one embodiment, the pathway wall 1392C can assist in defining and/or creating the retention pathway 1390 that allows a cam follower (not illustrated) of the gearing mechanism to follow. The retention cam 1387 can also have one or more securing apertures 1391 that allow the retention cam 1387 to be secured to the input cam shaft (not illustrated) and/or other devices, mechanisms, and/or systems.

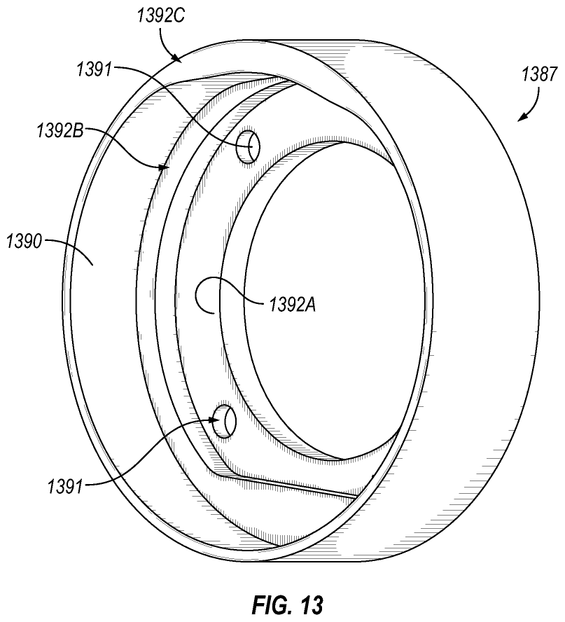

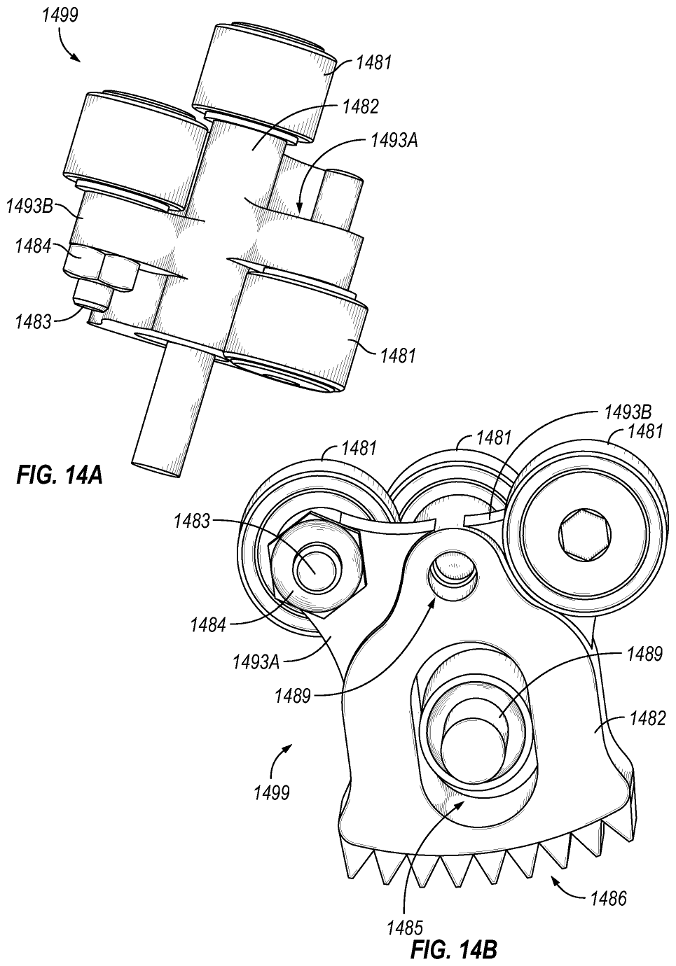

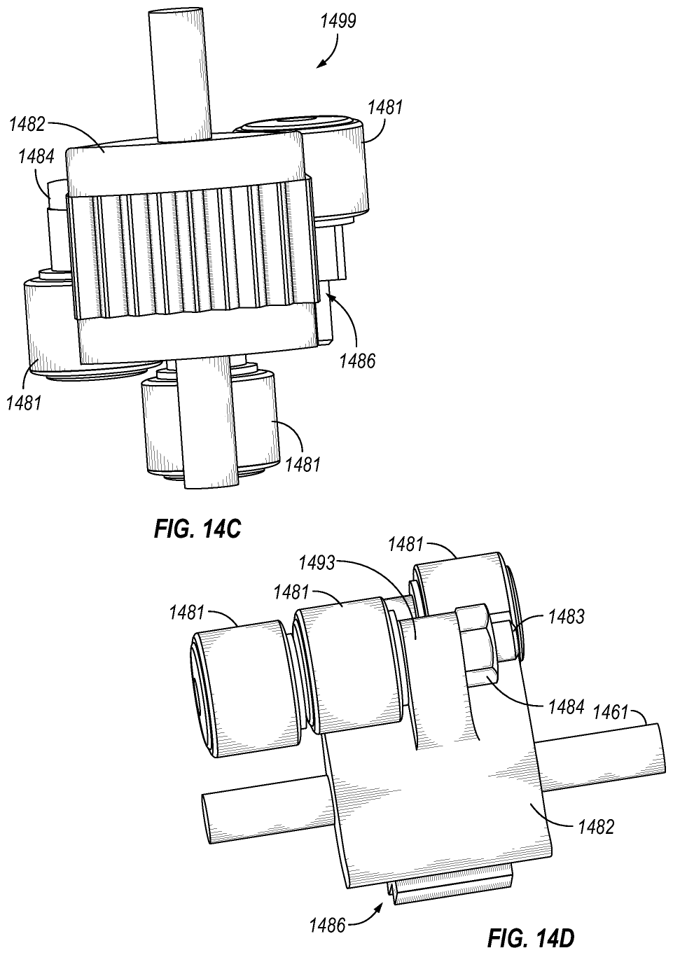

FIG. 14A is a rear view illustration of a gear block and cam follower assembly 1499. The gear block and cam follower assembly 1499 makes up a portion of the gearing mechanism (not illustrated). The gear block and cam follower assembly 1499 can include one or more cam follower(s) 1481, the gear block 1482, an engagement pin 1483, one or more securing mechanisms 1484, and/or gear block arms 1493A/1493B. In at least one example, the gear block arms 1493A/1493B can each have one or more cam follower(s) 1481 coupled to them via a securing mechanism 1484. In some example, the gear block arms 1493A/1493B may have a post that allows for a portion of a securing mechanism 1484 to be engaged and/or secure a cam follow 1481. Additionally, at least one cam follower 1481 is coupled directly to the gear block 1482 to allow for direct movements of the gear block. For example, the directly coupled cam follower 1481 may cause the radial movements of the gear block 1482.

FIG. 14B is a top view illustration of a gear block and cam follower assembly 1499. The gear block and cam follower assembly 1499 makes up a portion of the gearing mechanism (not illustrated). The gear block and cam follower assembly 1499 can include one or more cam follower(s) 1481, the gear block 1482, an engagement pin 1483, one or more securing mechanisms 1484, and/or gear block arms 1493A/1493B. Additionally, the gear block 1482 can have a movement void 1485 that can receive the engagement pin(s) 1483. In at least one example, the gear block 1482 can have two or more cam follower(s) 1481 that have an engagement pin portion that can engage with a securing mechanism 1484.

In at least one example, the gear block arms 1493A/1493B can each have one or more cam follower(s) 1481 coupled to them via a securing mechanism 1484. In some example, the gear block arms 1493A/1493B may have a post that allows for a portion of a securing mechanism 1484 to be engaged and/or secure a cam follow 1481. Additionally, at least one cam follower 1481 is coupled directly to the gear block 1482 to allow for direct movements of the gear block. For example, the directly coupled cam follower 1481 may cause the radial movements of the gear block 1482.

In at least one example, an engagement pin 1483 (in other examples may be referenced as a rotation pin for the carrier (not illustrated)) that passes through a movement void 1485, and/or a void bearing 1489. In at least one example the void bearing 1489 may alternatively be a roller or set of ball bearings that allow the engagement pin 1483 to move with the movement void 1487 in a specified manner. The gear block 1482 may include a set of gear teeth 1486 that allow for interaction with a ring gear or other set of opposing gear teeth that can assist in facilitating movement. Additionally, the cam follower(s) 1481 may be secured with a securing mechanism 1484. In at least one example, the securing mechanism 1484 may include a both or other threaded device that engages with a nut or other securable device.

FIG. 14C is a front view illustration of a gear block and cam follower assembly 1499. The gear block and cam follower assembly 1499 makes up a portion of the gearing mechanism (not illustrated). The gear block and cam follower assembly 1499 can include one or more cam follower(s) 1481, the gear block 1482, and/or an engagement pin 1483. Additionally, at least one cam follower 1481 is coupled directly to the gear block 1482 to allow for direct movements of the gear block. For example, the directly coupled cam follower 1481 may cause the radial movements of the gear block 1482.

In at least one example, an engagement pin 1483 (in other examples may be referenced as a rotation pin for the carrier (not illustrated)) that passes through a movement void (not illustrated), and/or a void bearing (not illustrated). The gear block 1482 may include a set of gear teeth 1486 that allow for interaction with a ring gear or other set of opposing gear teeth that can assist in facilitating movement.

FIG. 14D is a side view illustration of a gear block and cam follower assembly 1499. The gear block and cam follower assembly 1499 makes up a portion of the gearing mechanism (not illustrated). The gear block and cam follower assembly 1499 can include one or more cam follower(s) 1481, the gear block 1482, an engagement pin 1483, one or more securing mechanisms 1484, and/or gear block arms 1493A/1493B. Additionally, the gear block 1482 can have a movement void (not illustrated) that can receive the rotational pin(s) 1461. In at least one example, the gear block 1482 can have two or more cam follower(s) 1481 that have an engagement pin portion that can engage with a securing mechanism 1484.

In at least one example, the gear block arms 1493A/1493B can each have one or more cam follower(s) 1481 coupled to them via a securing mechanism 1484. In some example, the gear block arms 1493A/1493B may have a post that allows for a portion of a securing mechanism 1484 to be engaged and/or secure a cam follow 1481. Additionally, at least one cam follower 1481 is coupled directly to the gear block 1482 to allow for direct movements of the gear block. For example, the directly coupled cam follower 1481 may cause the radial movements of the gear block 1482.

The gear block 1482 may include a set of gear teeth 1486 that allow for interaction with a ring gear or other set of opposing gear teeth that can assist in facilitating movement. Additionally, the cam follower(s) 1481 may be secured with a securing mechanism 1484. In at least one example, the securing mechanism 1484 may include a threaded device that engages with a nut or other securable device and/or an engagement pin 1483. A rotational pin 1461 may also be present for engagement with a carrier (not illustrated).

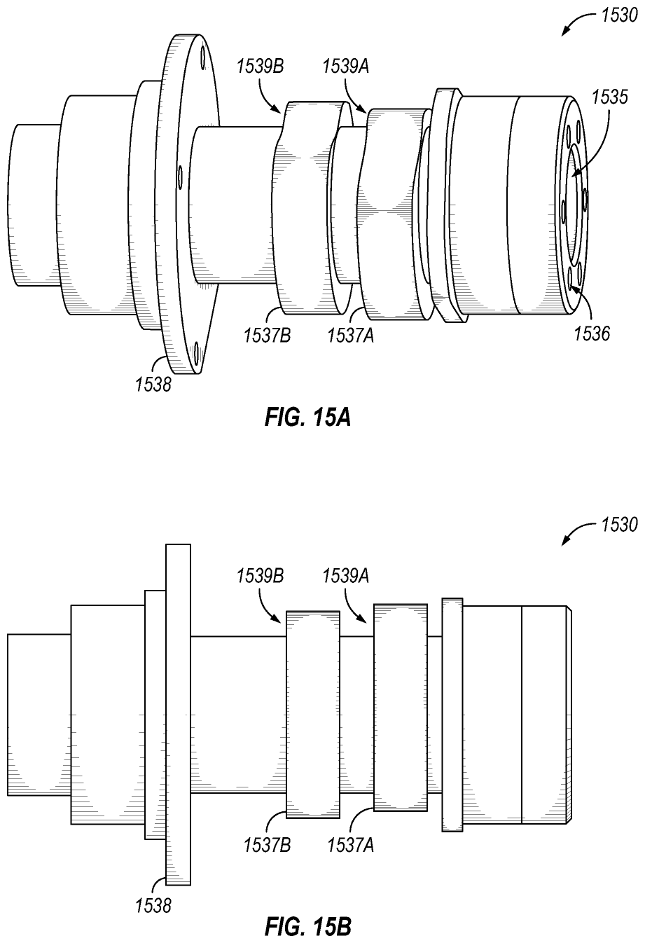

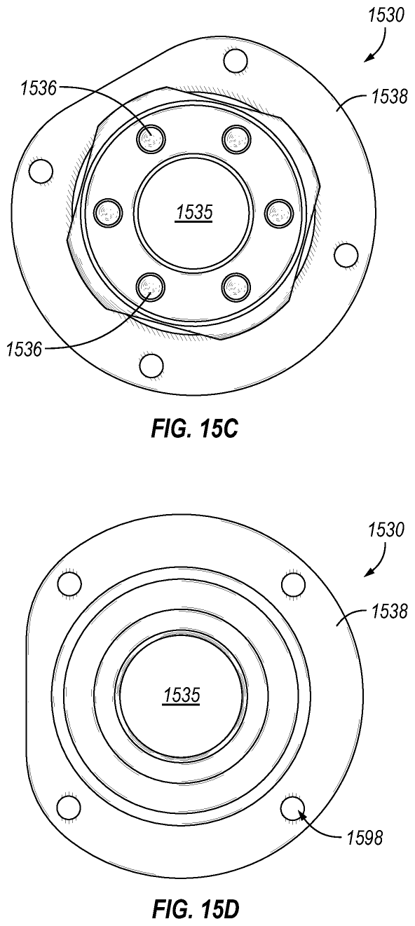

FIG. 15A is a side view illustration of an input cam shaft 1530. A gearing mechanism (not illustrated) may engage with an input cam shaft 1530 that can rotate about a central axis. In at least one embodiment, the central axis may pass through a central aperture 1535 defined by the input cam shaft 1530. Surrounding the central aperture 1535 can be multiple sections and/or surfaces of the input cam shaft 1530, including but not limited to a bearing surface or section 1533 that allows for bearings, or rollers or other devices, systems, or mechanisms that allow for freedom of rotation to be utilized in a manner that allows the input cam shaft to freely rotate about an axis passing through its length. There can also be a buffer section 1534 that can engaged with other portions of a gearbox (not illustrated), or an input or output device, system, or mechanism (not illustrated).

In at least one example, the input cam shaft 1530 can have at least one mounting aperture(s) 1536, which can be utilized to couple the input cam shaft 1530 to an input device, mechanism or system (not illustrated). This input device, mechanism, or system (not illustrated) can impart a rotational movement on the input cam shaft 1530 that causes its rotation and also the rotation of the cam pathway(s) 1537A/1537B. These cam pathways 1537A/1537B can interact with the cam follower(s) (not illustrated). As the cam follower(s) (not illustrated) move in correspondence to the cam pathway(s) 1537A/1537B they can impart movement in two dimensions on the gear block(s) (not illustrated). The cam pathway 1537A may have a pathway extension 1539A, while cam pathway 1537B may have a pathway extension 1539B. These pathway extensions 1539A/1539B may extend radially outward from the input cam shaft, to cause a rise and/or fall, or a ramping effect for the cam pathway(s) 1537A/1537B. In at least one example, each of the cam pathway(s) 1537A/1537B may have one or more pathway extensions to assist in the movements of the gear block (not illustrated). As seen in the figure, the pathway extensions 1539A/1539B are offset from one another along a circumferential surface of the input cam shaft 1530. Similarly, the cam pathway(s) 1537A/1537B may be offset and extend radially from the circumferential surface of the input cam shaft

In at least one embodiment, the input cam shaft 1530 may also have a blocking wall 1538 that assists in keeping the gearing mechanism 1580 contained. In some examples, the blocking wall 1538 may also be utilized to prevent materials such as, but not limited to sand, dirt or other materials from interacting with the gearing mechanism, and thus preventing possible damage to the gearing mechanism and/or gearbox (not illustrated).

FIG. 15B is an alternative side view illustration of an input cam shaft 1530. A gearing mechanism (not illustrated) may engage with an input cam shaft 1530 that can rotate about a central axis. In at least one embodiment, the central axis may pass through a central aperture 1535 defined by the input cam shaft 1530. Surrounding the central aperture 1535 can be multiple sections and/or surfaces of the input cam shaft 1530, including but not limited to a bearing surface or section 1533 that allows for bearings, or rollers or other devices, systems, or mechanisms that allow for freedom of rotation to be utilized in a manner that allows the input cam shaft to freely rotate about an axis passing through its length. There can also be a buffer section 1534 that can engage other portions of a gearbox (not illustrated), or an input or output device, system, or mechanism (not illustrated).

In at least one example, the input cam shaft 1530 can have at least one mounting aperture(s) 1536, which can be utilized to couple the input cam shaft 1530 to an input device, mechanism or system (not illustrated). This input device, mechanism, or system (not illustrated) can impart a rotational movement on the input cam shaft 1530 that causes its rotation and also the rotation of the cam pathway(s) 1537A/1537B. These cam pathways 1537A/1537B can interact with the cam follower(s) (not illustrated). As the cam follower(s) (not illustrated) move in correspondence to the cam pathway(s) 1537A/1537B they can impart movement in two dimensions on the gear block(s) (not illustrated). The cam pathway 1537A may have a pathway extension 1539A, while cam pathway 1537B may have a pathway extension 1539B. These pathway extensions 1539A/1539B may extend radially outward from the input cam shaft, to cause a rise and/or fall, or a ramping effect for the cam pathway(s) 1537A/1537B. In at least one example, each of the cam pathway(s) 1537A/1537B may have one or more pathway extensions to assist in the movements of the gear block (not illustrated). As seen in the figure, the pathway extensions 1539A/1539B are offset from one another along a circumferential surface of the input cam shaft 1530. Similarly, the cam pathway(s) 1537A/1537B may be offset and extend radially from the circumferential surface of the input cam shaft

In at least one embodiment, the input cam shaft 1530 may also have a blocking wall 1538 that assisting in keeping the gearing mechanism 1580 contained. In some example, the blocking wall 1538 may also be utilized to prevent materials such as, but not limited to sand, dirt or other materials from interacting with the gearing mechanism, and thus preventing possible damage to the gearing mechanism and/or gearbox (not illustrated).

FIG. 15C is a top view illustration of an input cam shaft 1530. A gearing mechanism (not illustrated) may engage with an input cam shaft 1530 that can rotate about a central axis. In at least one embodiment, the central axis may pass through a central aperture 1535 defined by the input cam shaft 1530. Surrounding the central aperture 1535 can be multiple sections and/or surfaces of the input cam shaft 1530, including but not limited to a buffer section 1534 that can engaged with other portions of a gearbox (not illustrated), or an input or output device, system, or mechanism (not illustrated). The buffer section 1534 may also have a set of buffer protrusions 1598 that can assist in containing, and/or orienting the input cam shaft 1530 or other portions of the gearbox (not illustrated).

In at least one example, the input cam shaft 1530 can have at least one mounting aperture(s) 1536, which can be utilized to couple the input cam shaft 1530 to an input device, mechanism or system (not illustrated). In at least one embodiment, the input cam shaft 1530 may also have a blocking wall 1538 that assisting in keeping the gearing mechanism 1580 contained. In some examples, the blocking wall 1538 may also be utilized to prevent materials such as, but not limited to sand, dirt or other materials from interacting with the gearing mechanism, and thus preventing possible damage to the gearing mechanism and/or gearbox (not illustrated).

FIG. 15D is a bottom view illustration of an input cam shaft 1530. A gearing mechanism (not illustrated) may engage with an input cam shaft 1530 that can rotate about a central axis. In at least one embodiment, the central axis may pass through a central aperture 1535 defined by the input cam shaft 1530. Surrounding the central aperture 1535 can be multiple sections and/or surfaces of the input cam shaft 1530. In at least one embodiment, the input cam shaft 1530 may also have a blocking wall 1538 that assisting in keeping the gearing mechanism 1580 contained. In some example, the blocking wall 1538 may also be utilized to prevent materials such as, but not limited to sand, dirt or other materials from interacting with the gearing mechanism, and thus preventing possible damage to the gearing mechanism and/or gearbox (not illustrated). In some examples, the blocking wall 1538 may have a set of coupling apertures 1598 that pass through it, and allow for a coupling to occur.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A gear box mechanism comprising:
a carrier configured to house a plurality of gear blocks, a retainer cam, a cam shaft, and a plurality of cam followers;
a ring gear;
an output;
wherein the plurality of cam followers engage with the cam shaft and the retention cam;
wherein the plurality of gear blocks are actuated based on the position of the plurality of cam followers along the retention cam and the cam shaft.

2. The gear box mechanism of claim 1, further comprising a first lid engaged with the carrier by a set of fasteners.

3. The gear box mechanism of claim 1, further comprising a second lid engaged with the carrier by a set of fasteners.

4. The gear box mechanism of claim 1, wherein the cam shaft has a plurality of cam pathways along an outer circumferential surface of the cam shaft.

5. The gear box mechanism of claim 1, wherein the retainer cam has a retention pathway along an inner surface of the retainer cam.

6. A gear box mechanism comprising:
a carrier configured to house portions of the gear box mechanism;
an input shaft having a plurality of cam pathways formed along the circumferential surface of the input shaft;
a set of cam followers;
a gear block coupled to the set of cam followers, wherein the gear block has a set of gear teeth opposite from where the set of com followers are coupled;
a ring gear that is circular and defining a central aperture that has a set of gear teeth along the inner circumference, wherein the set of gear teeth for the gear block engage with the set of gear teeth for the ring gear;
a retention cam that is circular with an outer wall that is perpendicular to a coupling surface, wherein the outer wall has a retention pathway along its inner surface that allows for engage with one or more of the set of cam followers; and
a set of lids that are coupled to the ring gear.

7. The gear box mechanism of claim 6, wherein the carrier is cylindrical having an input section, a gear block section, and an output section.

8. The gear box mechanism of claim 7, wherein the input section defines a central opening that passes through the carrier's length, surrounding the central opening is a input section wall that at one end has at least one mounting aperture that allow for engagement with at least one fastener.

9. The gear box mechanism of claim 7, wherein the output section defines the central opening that passes through the carrier's length.

10. The gear box mechanism of claim 9, wherein surrounding the central opening is an output section wall that at one end has at least one securing aperture that allows for engagement with at least one fastener.

11. The gear box mechanism of claim 7, wherein the gear block section defines that central opening that passes through the carrier's length.

12. The gear box mechanism of claim 11, wherein surrounding the central opening is a block section wall that comprises at least one gear block opening that passes completely through the block section wall.

13. The gear box mechanism of claim 12, wherein the at least one gear block opening is rectangular with rounded corners where on the inner edge of the block section wall at opposing corners of the at least one gear block opening there is a right angle recess that extends a portion of the way through the block section wall.

14. The gear box mechanism of claim 6, wherein the input shaft is coaxial to the carrier and internal of the carrier.

15. The gear box mechanism of claim 6, wherein the gear teeth of the gear block interface with ring gear resulting in zero backlash.

16. A gear box mechanism comprising:
a carrier configured to house portions of the gear box mechanism;
wherein the carrier is a cylindrical having an input section, a gear block section, and an output section;
wherein the input section defines a central opening that passes through the carrier's length, surrounding the central opening is a input section wall that at one end has at least one mounting aperture that allow for engagement with at least one fastener;
wherein the output section defines the central opening that passes through the carrier's length, surrounding the central opening is a output section wall that at one end has at least one securing aperture that allow for engagement with at least one fastener; and
wherein the gear block section defines that central opening that passes through the carrier's length, surrounding the central opening is a block section wall that comprises at least one gear block opening that passes completely through the block section wall, and the at least one gear block opening being rectangular with rounded corners where on the inner edge of the block section wall at opposing corners of the at least one gear block opening there is a right angle recess that extends a portion of the way through the block section wall.

17. The gear box mechanism of claim 16, further comprising an input shaft having a plurality of cam pathways formed along the circumferential surface of the input shaft; and a set of cam followers.

18. The gear box mechanism of claim 17, further comprising a gear block coupled to the set of cam followers, wherein the gear block has a set of gear teeth opposite from where the set of cam followers are coupled.

19. The gear box mechanism of claim 18, further comprising a ring gear that is circular and defining a central aperture that has a set of gear teeth along the inner circumference; wherein the set of gear teeth for the gear block engage with the set of gear teeth for a ring gear.

20. The gear box mechanism of claim 18, further comprising a retention cam that is circular with an outer wall that is perpendicular to a coupling surface, wherein the outer wall has a retention pathway along its inner surface that allows for engage with one or more of the set of cam followers; and a set of lids that are coupled to the ring gear.
